(19) United States
(12) Patent Application Publication
(10) Pub. No.: US 2013/0041852 A1
(43) Pub. Date: Feb. 14, 2013

(54) CUSTOMIZABLE DYNAMIC RESOURCE REGULATING DEVICES AND METHODS

(71) Applicants: Jason Lee Ellis, San Diego, CA (US); Jeffrey Robert Kaufman, San Diego, CA (US)

(72) Inventors: Jason Lee Ellis, San Diego, CA (US); Jeffrey Robert Kaufman, San Diego, CA (US)

(73) Assignee: QUALCOMM Incorporated, San Diego, CA (US)

(21) Appl. No.: 13/346,473

(22) Filed: Jan. 9, 2012

Related U.S. Application Data
(60) Provisional application No. 61/523,169, filed on Aug. 12, 2011.

(51) Int. Cl. G06Q 50/06; G06Q 50/00

(52) U.S. Cl. 705/412; 705/400

(57) ABSTRACT

Devices and methods for regulating resource usage are described herein. In some aspects, devices and methods for customizable dynamic regulation of resource usage policies are provided. Techniques for identification and reconciliation of resource provider usage policies and custom usage policies for resource consuming devices are generally described.

### CROSS-REFERENCE TO RELATED APPLICATIONS

This application claims priority from U.S. Provisional Patent Application No. 61/523,169, entitled “Customizable Dynamic Resource Regulating Devices and Methods,” filed Aug. 12, 2011, which is incorporated by reference in its entirety.

### BACKGROUND

1. Field

The present application relates generally to resource allocation systems and more specifically to devices and methods for customizable dynamic regulation of resource usage.

2. Background

On a resource regulating device, such as a wireless smart-utility meter (e.g., a meter that has intelligence beyond simply keeping track of energy usage), two applications have been contemplated by the industry. One application is pre-paid utility credits where a customer may prepay a resource provider (e.g., a utility) for future service. In some implementations, the meter or other resource regulating device may be loaded with energy credits. The second application is real-time demand response where the meter or other resource regulating device may respond to commands from a rules-engine in a back-end control system of a resource provider. The resource regulating device may modify the power usage of various appliances or devices in a home or office to comply with the resource provider's rules. This allows the resource provider to effect a system-wide, overall reduction in energy usage, namely to avoid brown-out or black-out conditions on, for example, an energy utility grid. As these applications are focused on the resource provider, improvements to resource regulating devices directed to resource consumers are desirable.

### SUMMARY

The devices and methods of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of this invention provide advantages that include customizable usage policies for regulating resource consuming devices.

Certain aspects of the disclosure provide a resource regulating device. The resource regulating device includes a processor configured to receive user information defining a usage policy for a resource consuming device. The usage policy defines at least one action based on a policy parameter. The policy parameter includes one of a price, time, price schedule, stored resources, generated resources, resource credits, resource budget, resource provider, and resources consumed. The processor is further configured to obtain a second usage policy for the resource consuming device. The processor is also configured to select at least one of the usage policy for the resource consuming device and the second usage policy for the resource consuming device.

The processor may be further configured to transmit a signal to the resource consuming device in accordance with the usage policy. The usage policy may include a threshold value for the policy parameter. The usage policy may include a range of values for the policy parameter. The action of the usage policy may include one of turning the resource consuming device off, turning the resource consuming device on, time-shifting a function of the resource consuming device, time-shifting cycles of the resource consuming device, and drawing and storing the resource in the resource consuming device. The processor may be further configured to switch from a first resource provider to a second resource provider. The resource may be at least one of power, gas, and water. The processor may be further configured to communicate with the resource consuming device using one of a wired network and a wireless network. The second usage policy may be based at least in part on user information or be provided by a resource provider. Reconciling the usage policy and the second usage policy may include combining the usage policy and the second usage policy. The policy parameter may be received from a resource provider. The policy parameter may be received from the resource consuming device. The policy parameter may be received from a plurality of resource consuming devices coupled with the resource consuming device. The resource credits may be pre-paid resource credits. The resource credits may be post-paid resource credits. The resource regulating device may include a smart-meter. The resource regulating device may be coupled with a smart-meter. The user information received may be a usage policy program. The first processor may be configured to identify one or more usage policies for the resource consuming device based in part on the usage policy program. The user information received may be a third-party resource planner.

In another aspect, a method of regulating resource usage is provided. The method includes receiving user information defining a usage policy for a resource consuming device, the usage policy defining at least one action based on a policy parameter, the policy parameter comprising one of a price, time, price schedule, stored resources, generated resources, resource credits, resource budget, resource provider, and resources consumed. The method also includes receiving a second usage policy for the resource consuming device. The method further includes periodically receiving the policy parameter. The method also includes reconciling the usage policy and the second usage policy based at least in part on the policy parameter. The method includes transmitting a signal causing the execution of the action defined by the usage policy.

In the method, receiving user information may include receiving a threshold value for the policy parameter. In the method, receiving user information may include receiving a range of values for the policy parameter. In the method, transmitting a signal causing the execution of the action may include one of turning the resource consuming device off, turning the resource consuming device on, time-shifting a function of the resource consuming device, time-shifting cycles of the resource consuming device, and drawing and storing the resource in the resource consuming device. The method may further include switching from a first resource provider to a second resource provider. In the method, the resource consuming device may consume one of power, gas, and water. In the method, receiving may include wirelessly receiving. In the method, transmitting may include wirelessly transmitting. In receiving a second usage policy for the resource consuming device, user information defining the second usage policy for the resource consuming device may be received. Receiving the second usage policy may include receiving the policy from a resource provider. In the method, receiving the policy parameter may include receiving the policy parameter from a resource provider. In the method, receiving the policy parameter may include receiving the policy parameter from the resource consuming device. In the method, receiving the policy parameter may include receiving the policy parameter from a plurality of resource consuming devices coupled with the resource consuming device.

In yet another aspect, a resource regulating device is provided. The resource regulating device includes means for receiving user information defining a usage policy for a resource consuming device. The usage policy defines at least one action based on a policy parameter. The policy parameter includes one of a price, time, price schedule, stored resources, generated resources, resource credits, resource budget, resource provider, and resources consumed. The resource regulating device includes means for receiving a second usage policy for the resource consuming device. The resource regulating device includes means for periodically receiving the policy parameter. The resource regulating device includes means for reconciling the usage policy and the second usage policy based at least in part on the policy parameter. The resource regulating device includes means for transmitting a signal causing the execution of the action defined by the usage policy.

In yet another aspect, a non-transitory computer-readable medium comprising instructions is provided. The instructions, when executed by a processor of an apparatus, cause the apparatus to receive user information defining a usage policy for a resource consuming device. The usage policy defines at least one action based on a policy parameter. The policy parameter includes one of a price, time, price schedule, stored resources, generated resources, resource credits, resource budget, resource provider, and resources consumed. The instructions also cause the apparatus to receive as second usage policy for the resource consuming device. The instructions further cause the apparatus to periodically receive the policy parameter. The instructions further cause the apparatus to reconcile the usage policy and the second usage policy based at least in part on the policy parameter. The instructions further cause the apparatus to transmit a signal causing the execution of the action defined by the usage policy.

### BRIEF DESCRIPTION OF THE DRAWINGS

FIG. 1 shows an exemplary resource allocation system.

FIG. 2 shows a functional block diagram of an exemplary resource regulating device that may be employed within the resource allocation system of FIG. 1.

FIG. 3 shows a functional block diagram of an exemplary consumer usage profile processor that may be employed with the resource regulating device of FIG. 2.

FIG. 4 shows a process flow diagram of an exemplary process for applying usage policies.

FIG. 5 shows a process flow diagram of an exemplary process for reconciling usage policies

FIG. 6 shows an exemplary interface for the resource regulating device of FIG. 2.

FIG. 7 shows a flowchart for an exemplary method of regulating resource usage within the resource allocation system of FIG. 1.

FIG. 8 shows a functional block diagram of another exemplary resource regulating device that may be employed within the resource allocation system of FIG. 1.

### DETAILED DESCRIPTION

Various aspects of the novel apparatuses and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel apparatuses and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different resource regulating technologies and resource allocation system configurations, some of which are illustrated by way of example in the figures and in the following description of the preferred aspects. The detailed description and drawings are merely illustrative of the disclosure rather than limiting, the scope of the disclosure being defined by the appended claims and equivalents thereof.

Instead of solely complying with demand response events from a resource provider, it may be desirable to allow the resource consumer to configure and perform real-time demand response to optimize the resource usage. Optimizing the pre or post-paid resource credits or resource budget may also be desirable. The resource consumer may program their smart-meter or other resource regulating device with an algorithm to perform a self-triggered and/or automated personal demand response event based on a consumer programmable user profile in a resource regulating device. The usage policy is capable of co-existing and communicating with a separate provider demand response usage policy. As will be described, the custom usage policy may have multiple policy parameters and actions. Policy parameters may include the current pre-pay balance, various pre-pay balance limits, a list of critical and non-critical resource consuming devices in the home/office, and the current state of the provider demand response algorithm (e.g., the on/off/power-reduction state of various appliances/devices the utility demand response algorithm may be asserting) and/or special time of use or other fluctuating pricing inputs (such as current, historical, or future fee tariff information). Actions may include control signals for the various resource consuming devices in the home or office. These signals can be communicated over wired or wireless means.

The resource consumer may configure the resource regulating device to turn off various resource consuming devices in the home or office when certain pre-paid credit thresholds are met in an effort to extend, for as long as possible, the amount of credits available in the resource regulating device. The resource consuming devices may be controlled by the resource regulating device to lower the overall resource consumption to maximize the amount of pre-pay resource credits or to maximize the resource consumer's energy budget. In some implementations, two or more thresholds could be set where when the first threshold is met, certain non-critical resource consuming devices may be reduced in power (or time shifted to a lower cost time when time-of-use pricing is used); when the second threshold is met, non-critical resource consuming devices may be turned completely off. Multiple levels of actions may be specified applying progressively restrictive usage parameters including the full shutdown of energy flow. As such, the pre-paid balance or energy budget remaining in the resource regulating device is extended as long as possible. When resource consuming devices are to be turned off or time shifted, the usage policy may cause control and command signals to be transmitted to the resource consuming devices. The signals may be transmitted via wireless or wired connectivity technologies such as WiFi, Zigbee, Bluetooth, Zwave, HomePlug, or cellular connections.

In an example where power is the resource, if power pricing fluctuates to a higher price period, then other thresholds could be affected resulting in similar or different personal demand responses. Additionally, when power costs are lower, the usage policy could trigger the charging of power storage devices including battery systems, electric vehicles, hot water heaters, etc. Similarly, knowing that power prices are higher, the usage policy may trigger the reallocation of generated power from renewable generators, batteries, or other generating means such as fuel powered generators, to increase resource credits or revenue by selling at more premium times.

In some implementations, the actions of the usage policies are combined with the actions of the utility demand response policy such that the utility demand response actions (e.g., from some rules engine controlled by the utility) may override the user specified action of the usage policy. In some implementations, the opposite may occur thereby allowing for customizations of policies with varying degrees of priority of settings.

Accordingly, one or more aspects taught herein may be incorporated into a resource regulating or consuming device such as a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a smart-utility meter, an appliance, or any other suitable device that may be configured to consume a resource provided in a metered fashion such as power, gas, water, telephone, video content, audio content, multimedia content, network access, and delivery (e.g., postal services).

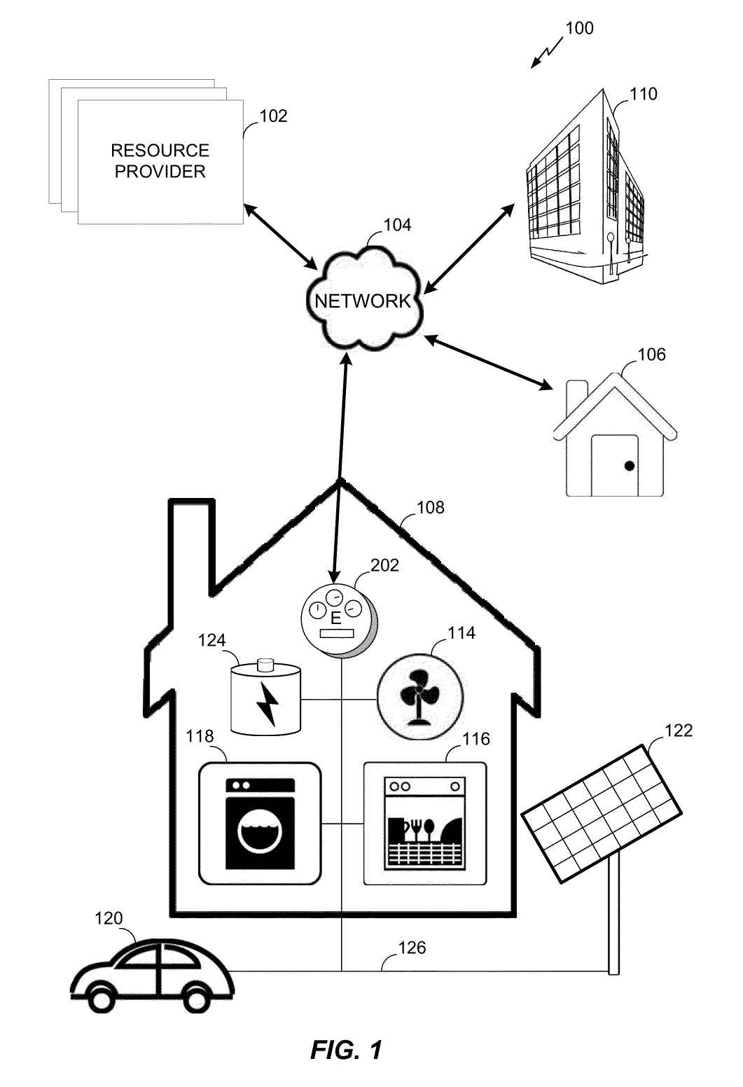

FIG. 1 shows an exemplary resource allocation system. The resource allocation system 100 may include one or more resource providers 102. The resource provider 102 may be a power provider, a water supplier, or a gas supplier. Other resource providers may also be included. The resource allocation system 100 may include one or more resource providers 102 for the same resource (e.g., two electricity providers). The resource provider 102 may connect to a network 104. The network 104 may be a resource transmission or distribution network (e.g., power lines, pipelines). The network 104 may be a communications network (e.g., the Internet, public switched telephone network, cellular). The resource provider 102 may connect to more than one network 104.

The network 104 may link the resource provider 102 with one or more resource consumers 114-124. The resource consumer may be a home 106 and 108. The resource consumer may be a building 110 (e.g., commercial, industrial, residential). The resource consumer 106, 108, and 110 may be configured to bi-directionally couple with the resource provider 102 via the network 104. In some implementations, the resource consumer 106, 108, and 110 may only receive transmissions from the resource provider 102 via the network 104. As with the resource provider 102, a resource consumer may connect to more than one network 104.

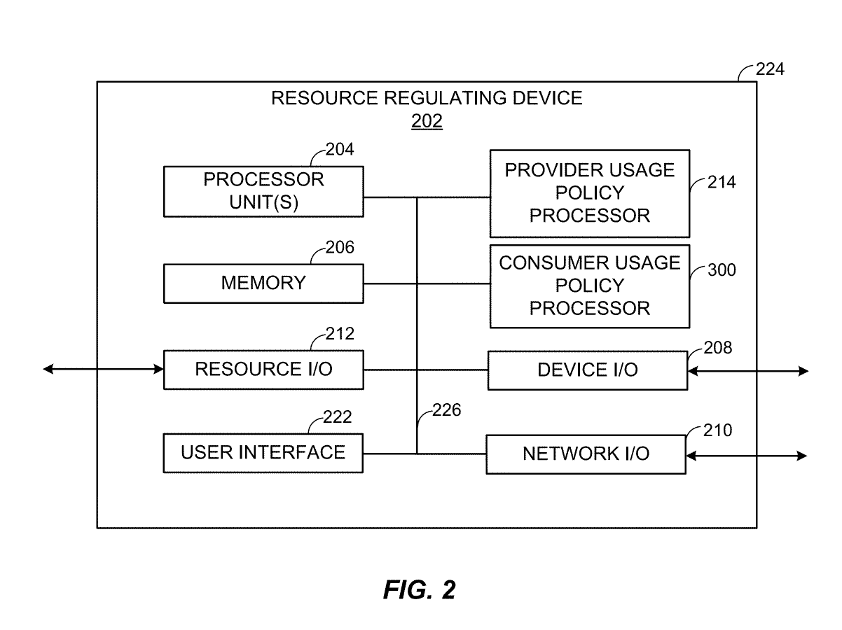

The resource consumer 108 may include a resource regulating device 202. As shown in FIG. 1, the resource regulating device 202 is a smart meter. However, in some implementations, the resource regulating device 202 may be a device coupled with a smart meter. For example, a smart meter can be in the neighborhood of the home, attached externally to the home, inside the home, or represented by a virtual presence due to remote metering. In some implementations, the resource regulating device 202 may be included in one or more of the devices shown. The resource regulating device 202 will be described in further detail in FIG. 2. In an implementation where the resource is power, the resource consumer 108 may include power consuming devices such as a fan 114, a dishwasher 116, a washing machine 118, and an electric vehicle 120. The resource consumer 108 may include a power producing device 122 that is configurable to produce resources. For example, where the resource is power, the resource consumer 108 may include power producing devices such as a solar panel array 122. The resource consumer 108 may include a power storage device 124 that is configurable to store resources. Resources may be stored from various elements of the resource allocation system such as the resource provider 102, the resource producer 122, or other resource consuming devices capable of storing the resource (e.g., drawing power stored in the battery of an electric car). For example, where the resource is power, the resource storage 124 can be a battery. The resource consuming devices 114-124 and the resource regulating device 202 may be coupled via a bus system 126. The bus system 126 may transmit resources and/or data between and amongst the power consuming devices 114-124 and the resource regulating device 202. The bus system 124 may be implemented wired or wirelessly. The bus system 124 may include a point-to-point system.

In some implementations, the resource consumer 108 draws a unit of the resource from the resource provider 102 via the network 104. The resource consumer 108 may decide how to allocate the unit of the resource amongst the connected resource consuming devices 114-124. In some implementations, the resource provider 102 may transmit pricing information to the resource consumer 108. If the price is favorable, the resource consumer 108 may draw units of the resource and store the units in the storage 124 for later use. When the price rises, the resource consumer 108 may then elect to use resources for one or more of the resource consuming devices 114-122 from the storage 124 rather than draw resources from the resource provider 102. In implementations where multiple resource providers 102 for the same resource are provided, the resource consumer 108 may alter the source of the resource based on, for example, transmitted pricing information to select the lowest cost provider.

FIG. 2 shows a functional block diagram of an exemplary resource regulating device that may be employed within the resource allocation system of FIG. 1. The resource regulating device 202 may comprise processor unit(s) 204 which may control operation of the resource regulating device 202. One or more of the processor unit(s) 204 may be collectively referred to as a central processing unit (CPU). Memory 206, which may include both read-only memory (ROM) and random access memory (RAM), provides instructions and data to the processor units 204. A portion of the memory 206 may also include non-volatile random access memory (NVRAM). The processor unit(s) 204 may be configured to perform logical and arithmetic operations based on program instructions stored within the memory 206. The instructions in the memory 206 may be executable to implement the methods described herein.

The processor unit(s) 204 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In an implementation where the processor unit(s) 204 include a DSP, the DSP may be configured to generate a packet for transmission. In some aspects, the packet may include a physical layer control protocol (PLCP) data unit (e.g., PPDU).

The resource regulating device 202 may also include machine-readable media for storing software. The processing unit(s) 204 may include one or more machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processor unit(s) 204, cause the resource regulating device 202 to perform the various functions described herein.

As shown in FIG. 2, the resource regulating device 202 may include a network input/output 210 to allow transmission and reception of data between the resource regulating device 202 and a remote location such as the resource provider 102 via the network 104. The network input/output 210 may be used to communicate with resource consuming devices of the resource consumer 108. Such resource consuming devices associated with the resource consumer 108 may be located at the same location as the resource regulating device 202, or the resource consuming devices may be distributed so as to be located in a different location than the resource regulating device 202. Accordingly, the network input/output 210 may be used to communicate with local or remote resource consuming devices. The network input/output 210 may be configured to communicate via wired connections such as Ethernet, optical, cable, telephone, power lines, and facsimile connections. In some implementations, the network input/output 210 may be configured to communicate via wireless connections such as Zigbee, WiFi, Bluetooth, Zwave, cellular, and radio connections. The resource regulating device 202 may also include (not shown) one or more antennae, transmitters, receivers, and/or transceivers to facilitate wired or wireless communications.

The network input/output 210 may be configured to wirelessly transmit packets and/or signals. For example, the network input/output 210 may be configured to transmit different types of packets generated by the processor unit(s) 204, discussed above. The packets are made available to the network input/output 201. For example, the processor unit(s) 204 may store a packet in the memory 206 and the network input/output 210 may be configured to retrieve the packet. Once the network input/output 210 retrieves the packet, the network input/output 210 transmits the packet.

The network input/output 210 of the resource regulating device 202 may detect the transmitted packets/signals. The resource regulating device 202 may be configured to process the detected packets/signals and make them available to the processor unit(s) 204. For example, the network input/output 210 may store the packet in the memory 206 and the processor unit(s) 204 may be configured to retrieve the packet from the memory 206 and process the packet.

The resource regulating device 202 may further include a resource input/output 212. The resource input/output 212 may be configured to draw units of the resource from a resource provider 102. The resource input/output 212 may be configured to transmit units of the resource to a resource provider 102. For example, in a power system, if the resource consumer 108 is coupled with solar panels 122, the resource consumer 108 may desire to sell-back power to the resource provider 102 (e.g., the electric company). The resource input/output 212 may be further configured to switch between resource providers 102. As discussed above, the price offered by one resource provider may be lower than the price offered by a second resource provider. The resource input/output 212 may be configured to alter the source of the resource based at least in part on this information. In some implementations, the resource input/output 212 may also select a resource storage device to draw resources from or store resources with.

In the example shown in FIG. 2, the resource regulating device 202 includes a provider usage policy processor 214. The provider usage policy processor 214 may be configured to receive a provider demand response signal from a resource provider 102. In some implementations, the provider demand response signal is send by the resource provider 102 on behalf of a third party (e.g., a government mandate). The resource provider 102 may transmit the provider demand response signal via the network 104. The resource regulating device 202 may receive the provider demand response signal via a network input/output 210. Via a bus system 226, the provider demand response signal may be transmitted from the network input/output 210 to the provider usage policy processor 214. In some implementations, the processor unit(s) 204 may process the provider demand response signal prior to transmitting the demand response signal to the provider usage policy processor 214 via the bus system 226. In some implementations, the processor unit(s) 204 or the network input/output 210 may store the provider demand response signal in the memory 206. The provider usage policy processor 214 can then access the memory 206 to retrieve the provider demand response signal. Where the resource is power, a resource provider 102 such as a utility company, may issue a provider demand response signal via the network 104 during periods of high power usage. The provider usage policy processor 214 may interpret the provider demand response signal. For example, if the provider demand response signal indicates a change in the quantity of the resource available from the resource provider 102, the provider usage policy processor 214 may alter the allocation of the available resources to the coupled resource consuming devices 114-124. In some implementations, the provider usage policy processor 214 may be configured to change the state (e.g., turn off) one or more resource consuming devices 114-124 in response to a provider demand response signal.

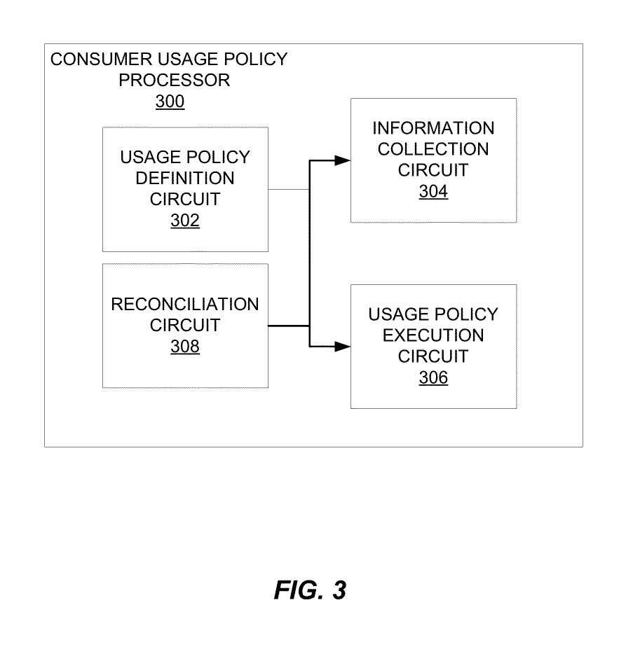

The resource regulating device 202 may further include a consumer usage policy processor 300 as shown in FIG. 3. The consumer usage policy processor 300 is similar to the provider usage policy processor 214 except the consumer usage policy processor 300 is managed by the resource consumer 108 rather than the resource provider 102. This provides the resource consumer 108 more control to regulate resource consumption. The consumer usage policy processor 300 is described further below in reference to FIG. 3.

The resource regulating device 202 may further include a device input/output 208. The device input/output 208 may be configured to receive signals from one or more resource consuming device 114-124 coupled with the resource regulating device 202. For example, the device input/output 208 may receive periodic status messages from a resource consuming device 114-124. The device input/output 208 may be configured to store these signals in the memory 206. The device input/output 208 may be configured to route specific signals to various components of the resource regulating device 202 via the bus system 226. For example, the device input/output 208 may transmit received signals to the processor unit(s) 204 and/or the consumer usage policy processor 300 for evaluation.

The device input/output 208 shown in FIG. 2 may be configured to transmit signals to one or more resource consuming device 114-124 coupled with the resource regulating device 202. The device input/output 208 may control various aspects of signal transmission such as encapsulation, encoding, encryption, conversion to resource consuming device specific control formats, assured signal delivery, re-transmission, and failover. For example, in response to a provider demand response signal, the provider usage policy processor 214 may transmit a signal to turn off a resource consuming device 114-124 to the device input/output 208.

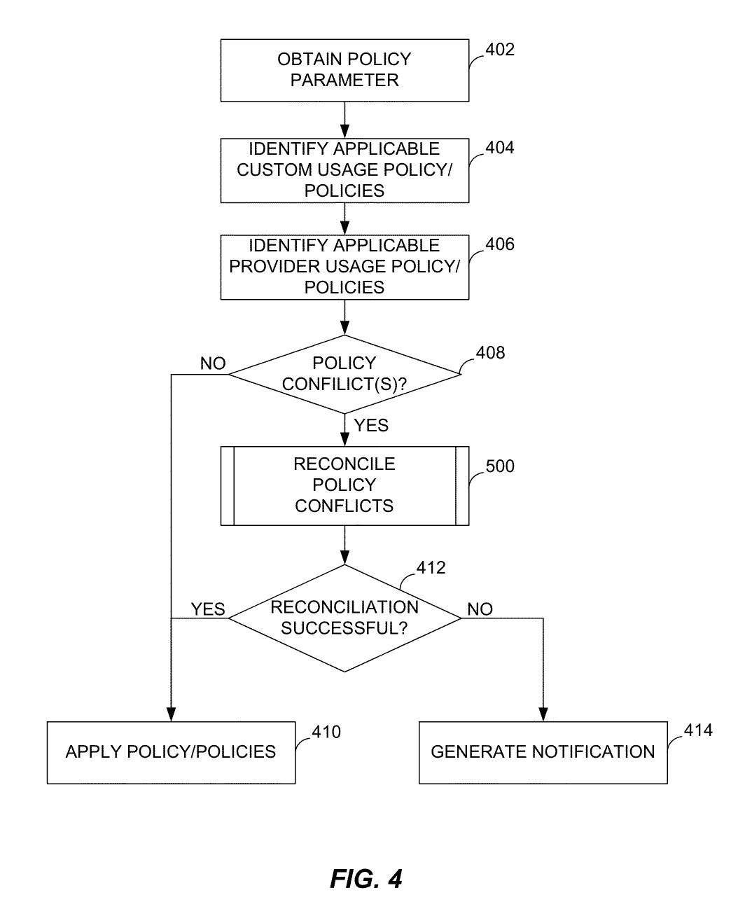

The resource regulating device 202 may further include a user interface 222 in some aspects. The user interface 222 may include a keypad, a microphone, a speaker, and/or a display. The user interface 222 may include any element or component that conveys information to a user of the resource regulating device 202 and/or receives input from the user. The user interface 222 may also include a browser based interface such as that described below in FIG. 4 accessible via the network 104. The resource regulating device 202 may also include a housing 224 surrounding one or more of the components included in the resource regulating device 202.

The various components of the resource regulating device 202 may be coupled together by a bus system 226. The bus system 226 may include a data bus, for example, as well as a power bus, a control signal bus, and a status signal bus in addition to the data bus. Those of skill in the art will appreciate the components of the resource regulating device 202 may be coupled together or accept or provide inputs to each other using some other mechanism.

Although a number of separate components are illustrated in FIG. 2, those of skill in the art will recognize that one or more of the components may be combined or commonly implemented. For example, the processor unit(s) 204 may be used to implement not only the functionality described above with respect to the processor unit(s) 204, but also to implement the functionality described above with respect to the provider usage policy processor 214 and/or the consumer usage policy processor 300. Further, each of the components illustrated in FIG. 2 may be implemented using a plurality of separate elements.

FIG. 3 shows a functional block diagram of an exemplary consumer usage policy processor that may be employed with the resource regulating device of FIG. 2. The consumer usage policy processor 300 may include a usage policy definition circuit 302. The usage policy definition circuit 302 may be configured to receive user information defining a usage policy for a resource consuming device 114-124. The usage policy may define at least one action the consumer usage policy processor 300 may cause to occur. For example, the consumer usage policy processor 300 may cause a resource consuming device 114-124 to switch into a stand-by mode. The action may include at least one of turning the resource consuming device off, turning the resource consuming device on, time-shifting a function of the resource consuming device, time-shifting cycles of the resource consuming device, and drawing and storing the resource in the resource consuming device.

The action may be based on a policy parameter. The policy parameter may include a price for the resource. For example, where water is the resource, the action of causing a resource consuming device, such as a sprinkler, to water a lawn for shorter period of time may be triggered if the price of water charged by the resource provider 102 exceeds a certain threshold.

The policy parameter may include time (for instance, current time, elapsed time of operation, or elapsed time of non-operation). For example, where power is the resource, the action of enabling non-critical power consuming device functions such as ice making in a refrigerator may be triggered between late night hours when power demand is low.

The policy parameter may include a price schedule. For example, the price may vary in accordance with time, date, location, resource provider, resource allocation system state, or other factors.

The policy parameter may include stored resources (for example, resources stored in a battery). The policy parameter referencing stored resources may indicate various characteristics of the stored resources such as an amount of the resource stored, a location where the resource is stored, how long the resource has been stored, and other conditions related to resource storage (such as temperature or pressure). For example, where gas is the stored resource, the action of switching a resource consuming device such as a grill from drawing resources from a resource provider 102 to drawing resources from a resource store 124 may be triggered if the pressure of a gas storage is equal to a specified pressure.

The usage policy definition circuit 302 of FIG. 3 may be configured to receive a policy parameter specifying generated resources (for example, wind turbine output, or water drawn from a well). For example, where power is the resource, the action of switching from drawing power from a resource provider 102 to drawing power from a power producing device that generates power 122 may be triggered if the amount of power produced exceeds a specified threshold. The policy parameter may include the identification of a particular resource provider. For example, where two utilities may provide service to an area, usage policy may be specified whereby the action is based on the resource provider 102 whereby the resource consumer 108.

The policy parameter may include resource credits (for instance, pre-paid energy credits). The policy parameter referencing resource credits may indicate various characteristics of the resource credits such as an amount of resource credits, the price the resource credits (for instance, price paid, current price, redemption price, historical prices, and derivations thereof), an expiration date/time for the resource credits, other resource credit usage limitations (for example, date, time of day, resource consuming device). For example, where the resource is power, the action of turning off non-critical power consuming devices may be triggered if the amount of resource credits available to a resource consumer 108 falls below a certain threshold. The policy parameter may include post-paid credits (e.g., amount to be billed). For example, where the resource is water, the action of turning off water supplied to a pool may be triggered if the amount of resource credits billable to a resource consumer 108 exceeds a certain threshold amount of credits the resource consumer 108 is willing to pay for.

The policy parameter may include a resource budget. For example, the resource consumer 108 may desire to spend only a certain amount (e.g., quantity of resources, cost) on the resource. The usage policy definition circuit 302 may be configured to receive the resource budget information for the resource consumer 108. The resource budget may specify an overall budget for the resource consumer 108 and/or a specific budget for each resource consuming device. In some implementations, such as for an apartment complex, the resource budget may specify a budget for multiple resource consumers 108.

The usage policy definition circuit 302 may be configured to receive a policy parameter specifying a characteristic of the resource consuming devices such as resource consuming device state (e.g., on, off, stand-by, limited function), resource consuming device type (e.g., climate control, lighting, communications), resource consuming device location, resource consuming device temperature, and resource consuming device uptime or downtime. For example, where gas is the resource, the action of turning off a gas heater may be triggered when an air conditioner in the same location changes to an “on” state. The usage policy definition circuit 302 may be configured to receive a policy parameter specifying the resources consumed. For example, where power is the resource consumed, the resource consumer 108 may identify a threshold specifying the maximum amount of resources a particular resource consuming device may consume. Should the resource consuming device exceed this threshold, the action may be to stop directing resources to the resource consuming device.

The policy parameter may include the current state of the provider demand response processor. For example, the on/off/power reduction state of various appliances/devices the provider demand response processor may be asserting.

The policy parameter may include the identity of the resource provider. In some implementations, consumers may prefer to obtain resources for a certain provider. For example, if given the choice between a renewable energy supplier and a non-renewable energy supplier, a consumer may prefer the renewable energy supplier over the non-renewable energy supplier. Consumers may be willing to pay more for renewable resources and thus may define a different policy including a cost policy parameter in conjunction with the resource provider. In these cases, defining a policy based in part on the identity of the resource provider may be desirable.

As described thus far, each action is associated with one policy parameter. In some implementations, the usage policy definition circuit 302 may be configured to receive a combination of multiple policy parameters to allow a resource consumer 108 to finely regulate the resource consuming devices 114-124 resource usage. The usage policy definition circuit 302 can be configured to receive logical operators such as “and”, “or”, “not” to combine multiple policy parameters for an action. The usage policy definition circuit 302 can be configured to receive temporal operators such as “while”, “until”, or “unless” to specify policy parameters for an action. Similarly, multiple actions may be associated with one or more policy parameters. For example, for a given set of policy parameters, the action may include several sub-actions for several resource consuming devices 114-124.

In the example shown in FIG. 3, the usage policy definition circuit 302 may be configured to store the usage policies in the memory 206. The usage policy definition circuit 302 may be further configured to allow modification of a previously defined usage policy. The usage policy definition circuit 302 may be configured to allow deletion of a previously defined usage policy.

The various actions and policy parameters received by the usage policy definition circuit 302 may be received from the resource consumer 108. In some implementations, the usage policy definition circuit 302 may be configured to receive usage policies from a third party resource planner. For example, the owner of an office in a commercial office building may allow a building manager to specify certain usage policies to coordinate and optimize the overall resource consumption for the tenants.

In some implementations, instead of receiving individual usage policies, the usage policy definition circuit 302 may receive a usage policy program. The policy program may be used by the usage policy definition circuit 302 or other elements of the device 202 to identify a pre-programmed usage policy for each resource consuming device. The pre-programmed usage policy and associated usage policy program may be stored in the memory 206. The pre-programmed usage policy may be retrieved from each resource consuming device by transmitting the usage policy program to the resource consuming device and receiving a corresponding usage policy. For example, the usage policy definition circuit 302 may receive a signal requesting the “summer” schedule. For resource consuming devices that consume power, this usage policy program may cause changes to the state of the heating and cooling systems to adjust for seasonal usage. In addition to seasonal usage policy programs, other examples of usage policy programs include programs based on occupancy (e.g., vacation, at home, at work) and activity (e.g., dinner party, movie watching). Thus, the usage policy program can allow a resource consumer 108 to manage several resource consuming devices by specifying a single usage policy program.

The consumer usage policy processor 300 may include an information collection circuit 304. The information collection circuit 304 may be configured to collect the various data elements used by the consumer usage policy processor 300 in defining, executing, and reconciling usage policies. For example, the information collection circuit 304 may interrogate resource consuming devices 114-124 coupled with the resource regulating device 202 via the bus system 226 through the device input/output 208 to identify policy parameter values or other characteristics of the resource consuming devices 114-124. The information collection circuit 304 may connect via the bus system 226 through the network input/output 210 to the network 104 to collect information from a remote information store. In some implementations, the remote information store may be the resource provider 102 or a government entity. The information collection circuit 304 may be configured to actively collect information and/or passively collect information transmitted through the resource allocation system 100.

The information collection circuit 304 may collect information according to a schedule. The schedule may be stored in the memory 206. The schedule may be pre-defined or user defined, for example through the user interface 222. The information collection circuit 304 may be configured to access the memory 206 to obtain the schedule. In some implementations, the processor unit(s) 204 may be configured to read the schedule and transmit a signal to the information collection circuit 304 identifying what information should be collected, from which source, and/or when. In some implementations, the schedule may be accessible from a networked resource, such as a scheduling web-service, remote data store, or the like. In some implementations, the remote data store may be a resource marketplace (not shown) including resource information such as resource price, resource providers, and resource credits.

The information collection circuit 304 of FIG. 3 may be configured to collect information in response to an event. For example, if the processor regulating device 202 receives a provider demand response signal, the information collection circuit 304 may be triggered to collect information. In some implementations, event detectors may be included to trigger the information collection circuit 304, such as an accelerometer, a thermometer, a barometer, a photodetector, a magnetometer, a radiation detector, an occupancy sensor, a motion sensor, and the like.

The information collection circuit 304 may be configured to store the collected information in the memory 206. Various elements of the resource regulating device 202 may be configured to retrieve the collected data from the memory 206. The information collection circuit 304 may transmit collected information directly to one or more elements of the resource regulating device 202 such as the processor unit(s) 204, the provider usage policy processor 214, the user interface 222, and one or more of the elements of the consumer usage policy processor 300.

The consumer usage policy processor 300 may include a usage policy execution circuit 306. The usage policy execution circuit 306 processes the defined usage policies. The usage policy execution circuit 306 may be configured to process the usage policies according to a schedule. The schedule may be stored in the memory 206. The schedule may be pre-defined or user defined, for example through the user interface 222 as discussed, for example, in FIG. 4 below. The usage policy execution circuit 306 may be configured to access the memory 206 to obtain the schedule. In some implementations, the processor unit(s) 204 may be configured to read the schedule and transmit a signal to the usage policy execution circuit 306 controlling the processing of the usage policies such as which usage policies to execute. In some implementations, the schedule may be accessible from a networked resource, such as a scheduling web-service, remote data store, or the like.

The usage policy execution circuit 306 may be configured to process usage policies in response to an event. For example, if the processor regulating device 202 receives a provider demand response signal, the usage policy execution circuit 306 may be triggered to process usage policies. In some implementations, event detectors may be included to trigger the usage policy execution circuit 306, such as an accelerometer, a thermometer, a barometer, a photodetector, a magnetometer, a radiation detector, an occupancy sensor, a motion sensor, and the like. In some implementations, the usage policy execution circuit 306 may be configured to process usage policies upon the completion of information collection by the information collection circuit 304.

In the example shown in FIG. 3, the usage policy execution circuit 306 may process the usage policies in a sequential order. The usage policy execution circuit 306 may process multiple usage policies in parallel. The usage policy execution circuit 306 may begin processing the usage policies by developing an execution plan based on such factors as the active usage policies, active provider demand response signals, time of day, resource consuming devices affected by the usage policies, and the like. The execution plan may provide a sequence for executing the usage policies. For example, an execution plan may reduce computation by identifying usage policies that are inapplicable at a given time. An execution plan may reduce data traffic, for example, by removing conflicting actions for a resource consuming device. For example, the execution plan may collect several usage policies for resource consuming device A together to determine what, if any, actions are applicable in relation thereto and transmit one signal to resource consuming device A rather than transmitting multiple signals for each usage policy.

Although a number of separate components are illustrated in FIG. 3, those of skill in the art will recognize that one or more of the components may be combined or commonly implemented. For example, the usage policy execution circuit 306 may be used to implement not only the functionality described above with respect to the usage policy execution circuit 306, but also to implement the functionality described above with respect to the reconciliation circuit 308 and/or the information collection circuit 304. Further, each of the components illustrated in FIG. 2 may be implemented using a plurality of separate elements.

During the algorithm execution, information may be needed to apply the usage policies such as the policy parameters, as discussed above. The usage policy execution circuit 306 may be configured to receive this information directly from the information collection circuit 304. The usage policy execution circuit 306 may be configured to receive this information from the memory 206. The usage policy execution circuit 306 may be configured to request this information from the information collection circuit 304.

As part of processing the usage policies, the usage policy execution circuit 306 may communicate with a reconciliation circuit 308 included in the consumer usage policy processor 300. Because multiple usage policies may be defined and provider demand response signals may also have been received by the resource regulating device 202, conflicts between two or more actions may arise. For example, the provider demand response signal may indicate a resource consuming device should turn off while a usage policy may indicate that the same resource consuming device should enter a low-power mode. As a second example, a first usage policy may indicate that a resource consuming device should turn on while a second usage policy may indicate that the resource consuming device should turn off. The reconciliation circuit 308 is configured to reconcile these types of conflicts.

In some implementations, the reconciliation circuit 308 may be configured to respond to the provider demand response signals. In these implementations, if any conflict arises between a provider demand response signal and a usage policy, the provider demand response signal may control the state of the system. In these implementations, the usage policy specified by the resource consumer 108 may be ignored.

In some implementations, the reconciliation circuit 308 may be configured to determine characteristics of the conflict and determine which should control. For example, if the provider demand response signal specifies a restriction on resource consumption to N units, the reconciliation circuit 308 may determine that a potentially conflicting first usage policy specifies an action plan that would result in a configuration consuming N-x units of the resource. In this example, the reconciliation circuit 308 may be configured to apply the first usage policy. In another example, if a first usage policy specifies an action that affects two power consuming devices, A and B, and a second usage policy specifies an action at affects power consuming device B, the reconciliation circuit 308 may combine the two usage policies, taking the action for power consuming device A from the first usage policy and the action for power consuming device B from the second usage policy. Examples of the reconciliation process are discussed in further detail below.

FIG. 4 shows a process flow diagram of an exemplary process for applying usage policies. The process may be implemented by a resource regulating device such as that shown in FIG. 2.

At block 402, a policy parameter is obtained. For ease of explanation, this implementation describes obtaining one policy parameter, however, in some implementations, one or more policy parameters may be obtained to identify and reconcile usage policies. As an example, the policy parameter obtained may be a resource credit price. As discussed above, in an electricity system, the price per unit of electricity may fluctuate during the course of the day. Usage policies may change how the system consumes electricity in response to the policy parameter.

At block 404, applicable custom usage policies are identified. The custom usage policies may be for a device, or a group of devices. The custom usage policy may be defined by the user as described above. In some implementations, the custom usage policy may be included in a usage policy program as further described above. As an example, the price per unit of electricity obtained may indicate that the price per unit is $1.20. The identification may include querying the defined custom usage policies to identify the custom usage policies which include price per unit policy parameters. In some implementations, no custom usage policies for a device or group of devices may be identified. In some implementations, one or more custom usage policies may be identified. This is one type of usage conflict the system can help reconcile.

At block 406, applicable provider usage policies are identified. The applicable provider usage policies may include demand response policies. In one implementation, the identification of the applicable provider usage policies may be based on the identified custom usage policies. For example, if a resource consumption device is identified as a potential candidate for custom usage policy, a provider usage policy may also apply. This is another type of conflict that the system can help reconcile. As with custom usage policies, at a given point in time, two or more provider usage policies may be identified. This is yet another type of conflict that the system can help reconcile.

At block 408, conflicts are identified. The system may be configured to identify a conflict as the situation where two or more usage policies may apply for a device. Determining whether a conflict exists may also include transmitting a signal indicating such a conflict has arisen. For example, a log may be kept indicating the device and usage policies conflicting. In some implementations, a notification of the conflict may be generated (e.g., text message, email). If no conflict is identified, at block 410, the identified polices are applied. In applying the usage policies, the state of the resource consuming devices may be altered as described above. If a conflict is identified, the conflicts are reconciled.

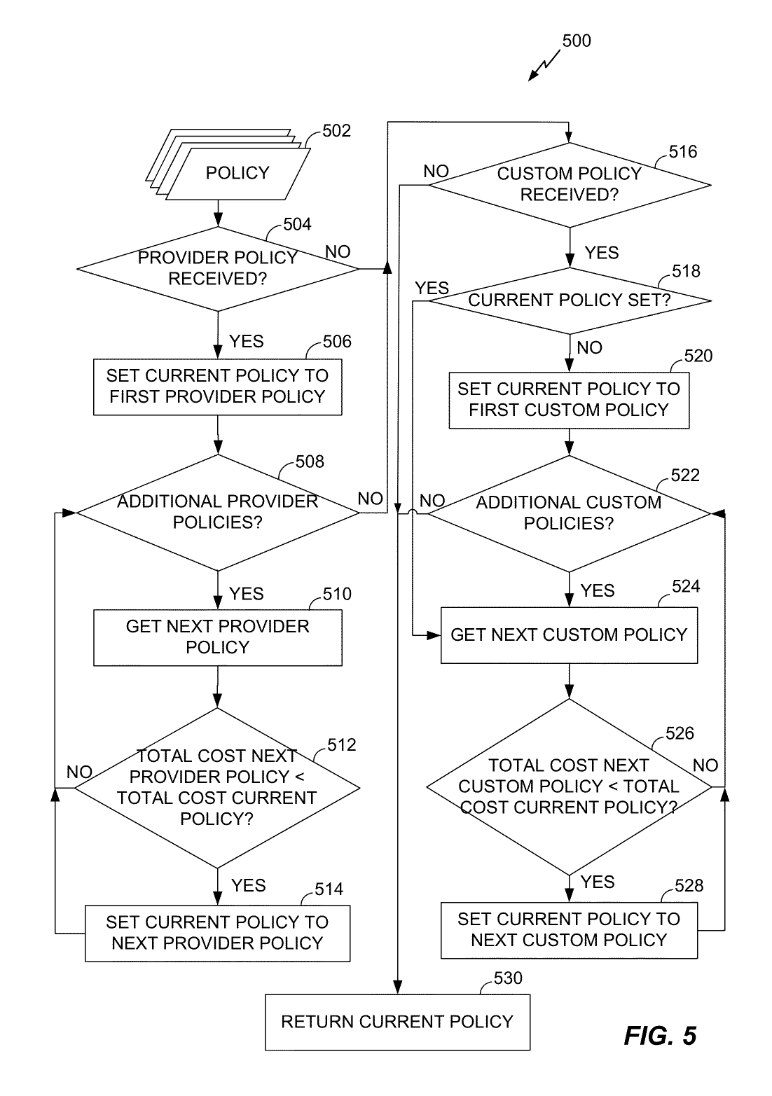

At block 500, the conflicting usage policies are reconciled. In some implementations, the system may be configured to reconcile by deferring to the provider usage policy. In these implementations, if one provider usage policy is identified for a device, this provider usage policy governs the usage of the resource consuming device. An example of a more complex reconciliation process is described in further detail in reference to FIG. 5.

In some implementations, reconciliation of the conflicting policies may result in combining features of the conflicting usage policies. For example, a first custom usage policy may be defined for an air conditioner which specifies the actions of raising the thermostat temperature and altering the operating state to “low” under certain conditions. A provider usage policy may be received which indicates the air conditioner be placed into an operating state of “off.” In this case, the non-conflicting action from the custom usage policy, raising the thermostat temperature, may be combined with the operating state setting of “off” from the provider usage policy. Thus, the conflicting usage policies are combined to generate a hybrid policy.

At decision block 412, it is determined whether the identified usage policies have been successfully reconciled. If the reconciliation was successful, the process 500 continues to block 410 where the policies are applied as described above. Returning to decision block 412, in some implementations, the process 500 may be unable to automatically reconcile the usage policies for a device or group of devices. In this case, the process 500 may continue to block 414 where a notification is generated. In one implementation, the notification may be a text message (e.g., short message system text message), an email, an automated voice call, or, in implementations including a user interface, a notification message for display on the user interface (e.g., textual, graphic, and/or multimedia).

FIG. 5 shows a process flow diagram of an exemplary process for reconciling usage policies. The process 500 may be implemented by a resource regulating device such as that shown in FIG. 2. The process 500 begins when two or more usage policies 502 are received.

At decision block 504, it is determined whether the received usage policies 502 include provider usage policies. If the received usage policies 502 include a provider usage policy, the process 500 continues to block 506. At block 506, one of the provider usage policies is identified as the current usage policy. In one implementation, the provider usage policies may be stored in a list and the identification may be based on the position in the list (e.g., first in the list, last in the list).

At decision block 508, the process determines whether there are any other provider usage policies. If there are additional provider usage policies to consider, the process continues to block 510. At block 510, another provider usage policy is identified as the next provider policy. For example, the identification of the next provider policy may be the next item on the list of provider usage policies.

At decision block 512, the process determines which policy, the current usage policy or the next usage policy, yields a more efficient result. In the example shown, the efficiency of a result is determined based on a total cost of the usage policy (e.g., amount of resource consumed at the current price). If the total cost of the next provider policy is higher than the total cost of the current usage policy, the current usage policy is deemed to be more efficient. In this case, the process may keep the current usage policy and return to block 508 to repeat the assessment for any remaining provider usage policies.

Returning to decision block 512, if the total cost of the next provider policy is lower than the total cost of the current usage policy, the next provider policy may be deemed to be more efficient. In this case, the process 500 identifies the next provider policy as the current usage policy at block 514. The process 500 then returns to block 508 to repeat the assessment for any remaining provider usage policies.

Returning to decision block 508, if no additional provider usage policies remain for assessment, the process 500 continues to block 516. At decision block 516, the process 500 determines whether the received usage policies 502 include custom usage policies. If the received usage policies 502 include a custom usage policy, the process 500 continues to block 518.

At decision block 518, the process determines if a current usage policy has been identified. If a current usage policy has been identified (e.g., a provider usage policy), the process continues to block 524 to identify a custom usage policy as the next custom policy. As with the provider usage policies, the custom usage policies may be represented in a list. Identifying the next custom policy may be based on the position of the custom usage policy in the list (e.g., first on the list, last on the list).

At decision block 526, the process 500 determines which policy, current usage policy or next custom policy, yields a more efficient result. The assessment may be performed similar to the assessment described above in reference to block 512. If the current usage policy is more efficient than the next custom policy, the process 500 continues to decision block 522 where a determination is made as to whether additional custom usage policies remain for assessment. If additional custom usage policies are to be assessed, the process 500 continues to block 524 as described above.

Returning to block 518, if a current usage policy has not been identified, the process 500 identifies a current usage policy from the provided custom usage policies. In one implementation, the custom usage policies may be stored in a list and the identification may be based on the position in the list (e.g., first in the list, last in the list). Once a current usage policy is identified, the process continues to block 522 as described above.

At block 522, if no additional custom usage policies are to be assessed, the process 500 continues to block 530. At block 530, the current usage policy may be provided as the policy to apply for the resource consuming device/device group governed by the provided policies 502. It will be appreciated that the assessment in this example reconciliation process may be expanded to include other factors or multiple factors. For example, the reconciliation may judge efficiency based on consumption totals, cost totals, device uptime, or other factors.

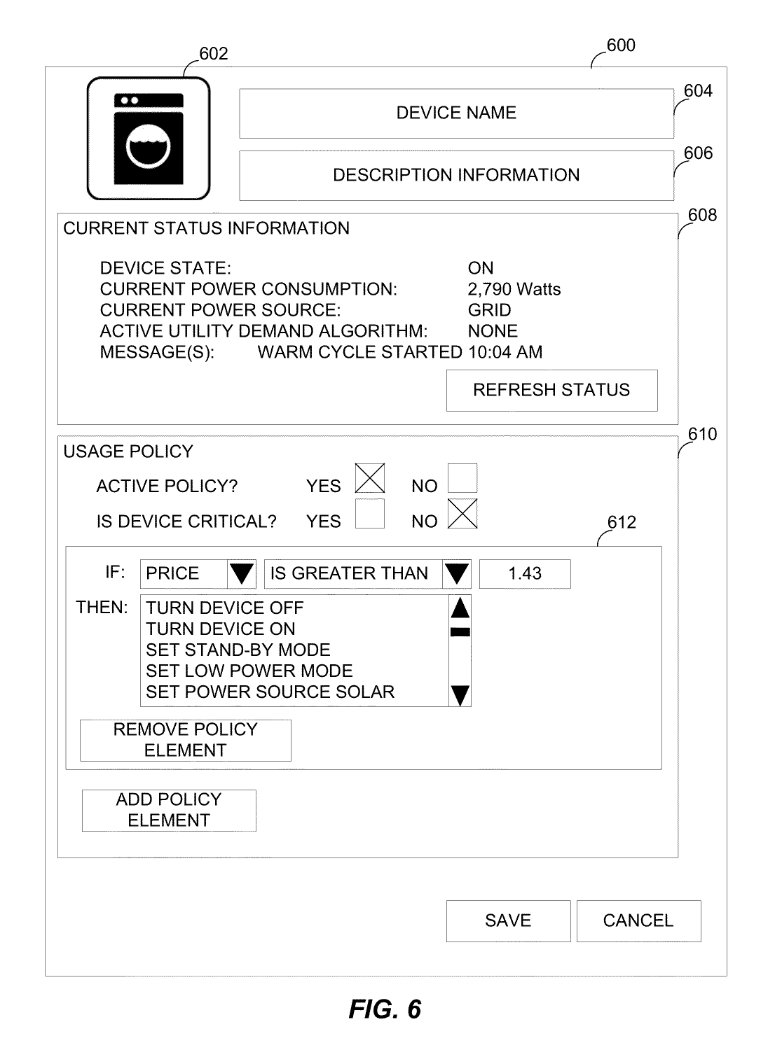

FIG. 6 shows an exemplary interface for the resource regulating device of FIG. 2. The interface 600 may be used to display information regarding a usage policy for a resource consuming device. In FIG. 6, the policy for a washing machine is shown. The interface 600 may include a picture 602 of the resource consuming device. The picture 602 may be user defined or obtained from the resource consuming device manufacturer. The interface 600 may include a device name section 604. The device name section 604 may include the name of the resource consuming device and/or a user specified name for the resource consuming device. The interface 600 may include description information section 606. The description information section 606 may display text, pictures, multimedia, or other information describing the resource consuming device such as manufacturer, product support information, usage tutorials, date of manufacture, serial number, device location (e.g., building, floor, office, room) and the like.

The interface 600 may include a current status information section 608. The current status information section 608 may include various characteristics of the resource consuming device such as the device state (e.g., on, off, low-power, limited function), current resource consumption of the resource consuming device, current source the resource consuming device is drawing resources from, if there are any active provider demand response events affecting the resource consuming device, and message(s) from the device. The current status information section 608 may include manufacturer specifications or parameters. For example, if operating conditions are outside of an expected range, an alert can be displayed recommending service or replacement. In some implementations, the alert may identify a resource consuming device that is failing, about to fail, under performing, or over consuming the resource. The alert may also provide information to assist in the repair of the device. The information may be provided via the interface 600 or transmitted directly to a service facility. The current status information section 608 may include one or more controls to adjust the current status information section 608 such as a refresh status button which may be configured to update the information included in the current status information section 608. The interface 600 may also include historical status information section (not shown). The historical status information section may include past information for the resource consuming device. Such trend information may provide insight for the consumer to consider such as when defining usage policies, assessing the quality of the resource consuming device, and the like. The historical information may be aggregated over time such as by year, month, day, hour, minute, or second. The historical status information may include data such as resource consuming device time of use, cost of usage, resource consumption. The information may be displayed in a table, graph, pie chart, or other suitable textual or graphical representation.

The interface 600 may include a usage policy section 610. As shown in FIG. 6, the example usage policy is tied to one device. However, as described above, a usage policy may be applied to more than one device. In FIG. 6, the example usage policy shown in the usage policy section 610 the usage policy section includes various usage policy definition fields. The usage policy section 610 includes an indicator as to whether the policy is active or inactive. The usage policy section 610 includes an indicator as to whether the resource consuming device is a critical device. As shown, the criticality of a resource consuming device is shown as a binary option, but it will be understood that the interface 600 may permit identification of a level of criticality ranging, for example, from absolutely critical to non-critical.

The usage policy section 610 may include a usage policy element section 612. The usage policy element section 612 allows a user to specify a policy parameter. In the example shown, the policy parameter selected is price. As shown, the usage policy element section 612 allows a user to specify the operator for the policy parameter. In the example shown, the operator selected is “is greater than.” As shown, the user policy element section 612 allows a user to specify a value to compare with the policy parameter. In the example shown, the value specified is “1.43”. The usage policy element section 612 permits a user to specify an action in response to satisfying the specified condition. In the example shown, a user may specify one or more actions such as “turn device on” and “set power source solar.” The usage policy element section 610 may include additional controls such as a “remove usage policy element” to remove the associated usage policy element.

The usage policy section 610 may include additional controls such as an “add usage policy element” to add another usage policy element for this usage policy. The interface 600 may include additional controls such as a save control. The save control may be configured to transmit the specified usage policy information to the resource regulating device 202 for processing, for example by the usage policy definition circuit 302. The usage policy definition circuit 302 may validate, verify, store, and otherwise process the usage policy as discussed above. In some implementations, the resource consuming device may have a default usage policy specified, for instance, by resource consuming device the manufacturer or resource regulating device. The interface may include a restore default control to specify the default usage policy for the identified device.

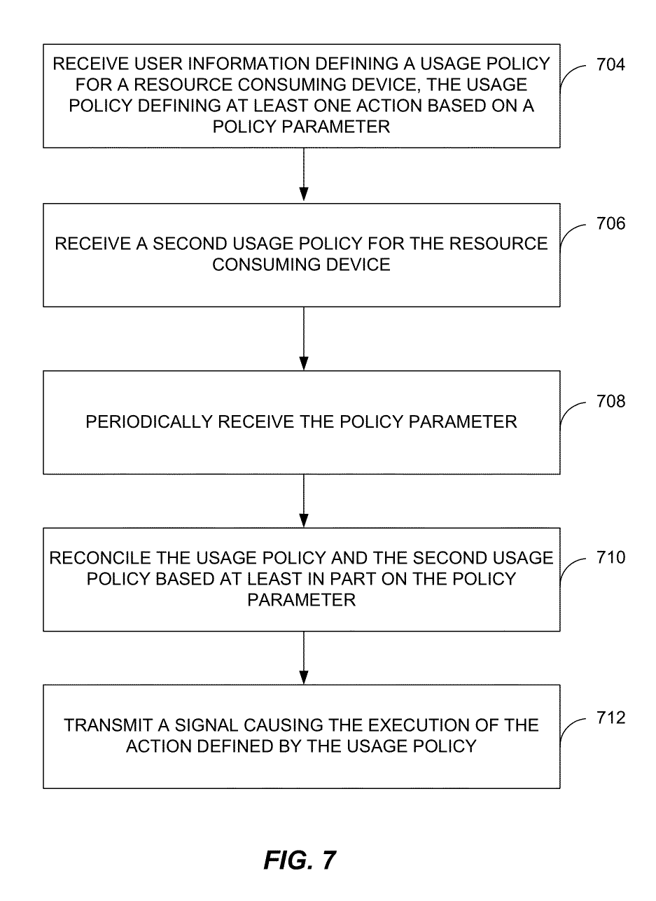

FIG. 7 shows a flowchart for an exemplary method of regulating resource usage within the resource allocation system of FIG. 1. At block 704, user information is received defining a usage policy for a resource consuming device. As described above, this may involve the usage policy definition circuit 302. In some implementations receiving may include a user interface 222. The usage policy defines at least one action based on a policy parameter, as described above. At block 706, a second usage policy for the resource consuming device is received. At block 708, the policy parameter is periodically received. As described above, the information collection circuit 304 may receive the policy parameter unsolicited or in response to a request for information. At block 710, the usage policy and the second usage policy are reconciled based at least in part on the policy parameter. In some implementations, the policy parameter may be evaluated when received, such as by the information collection circuit 304 or the processor unit(s) 204. In some implementations, the policy parameter may be evaluated when the usage policy is evaluated, for example during processing of the usage policy by the usage policy execution circuit 306. The policy parameter may be provided to the reconciliation circuit 308 for reconciling the usage policy and the second usage policy. At block 712, a signal is transmitted causing the execution of the action defined by the usage policy. For example, as described above, the usage policy execution circuit 306 may transmit a signal via the bus system 226 to the device input/output 208 which may cause a change to a resource consuming device 114-124 coupled with the consumer usage policy processor 300.

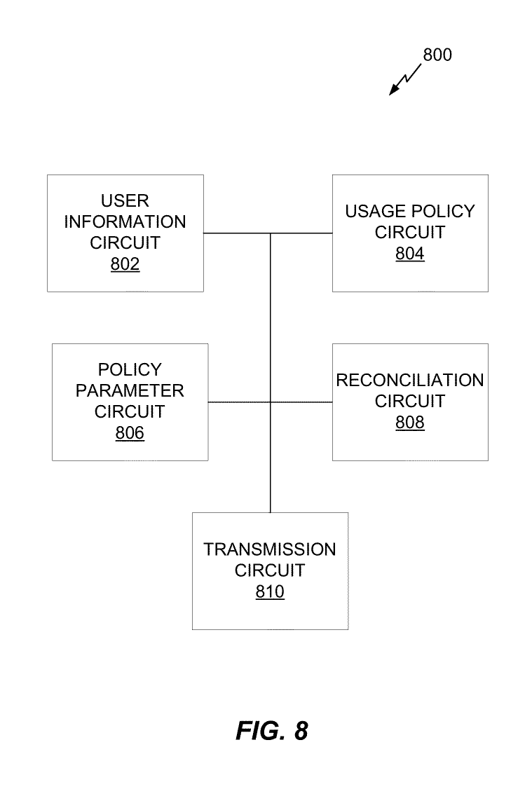

FIG. 8 shows a functional block diagram of another exemplary resource regulating device that may be employed within the resource allocation system of FIG. 1. The exemplary resource regulating device 800 may be used to implement one or more of the methods described above. Those skilled in the art will appreciate that a resource regulating device may have more components than the simplified resource regulating device 800 shown in FIG. 8. The resource regulating device 800 shown includes only those components useful for describing some prominent features of certain implementations. The resource regulating device 800 includes a user information circuit 802, a usage policy circuit 804, a policy parameter circuit 806, a reconciliation circuit 808, and a transmission circuit 810.

In some implementations, the user information circuit 802 is configured to receive user information defining a usage policy for a resource consuming device. The usage policy may define at least one action based on a policy parameter. The policy parameter may include one of a price, time, price schedule, stored resources, generated resources, resource credits, resource budget, resource provider, and resources consumed. The user information circuit 802 may include one or more of a consumer usage policy processor, a device input/output (I/O), and a user interface. In some implementations, the means for receiving user information may include the user information circuit 802.

The usage policy circuit 804 may be configured to receive a second usage policy for the resource consuming device. The usage policy circuit 804 may include one or more of a user interface, a memory, a provider usage policy processor, and a consumer usage policy processor. In some implementations, the means for receiving a second usage policy may include the usage policy circuit 804.

In some implementations, the policy parameter circuit 806 may be configured to periodically receive the policy parameter. The policy parameter circuit 806 may include one or more of the network input/output (I/O) and processor unit(s). In some implementations, the means for periodically receiving the policy parameter may include the policy parameter circuit 806.

Some resource regulating devices 800 configure the reconciliation circuit 808 to reconcile the usage policy and the second usage policy based at least in part on the policy parameter. The reconciliation circuit 808 may include one or more of a memory, a provider usage policy processor and a consumer usage policy processor. In some implementations, the means for reconciling may include the reconciliation circuit 808.

In some implementations, the transmission circuit 810 may be configured to transmit a signal causing the execution of the action defined by the usage policy. The transmission circuit 810 may include one or more of a processor unit(s) and a device I/O. In some implementations, the means for transmitting may include the transmission circuit 810.

As used herein, the term “determining” encompasses a wide variety of actions. For example, “determining” may include calculating, computing, processing, deriving, investigating, looking up (for instance, looking up in a table, a database or another data structure), ascertaining and the like. Also, “determining” may include receiving (for example, receiving information), accessing (such as, accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may include non-transitory computer readable medium (for example, tangible media). In addition, in some aspects computer readable medium may include transitory computer readable medium (such as a signal). Combinations of the above should also be included within the scope of computer-readable media.

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may include a computer program product for performing the operations presented herein. For example, such a computer program product may include a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (such as, RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A resource regulating device comprising:
a processor configured to receive user information defining a usage policy for a resource consuming device, the usage policy defining at least one action based on a policy parameter, the policy parameter comprising one of a price, time, price schedule, stored resources, generated resources, resource credits, resource budget, resource provider, and resources consumed, the processor further configured to obtain a second usage policy for the resource consuming device, the processor further configured to select at least one of the usage policy for the resource consuming device and the second usage policy for the resource consuming device.

2. The resource regulating device of claim 1, wherein the processor is further configured to transmit a signal to the resource consuming device in accordance with the usage policy.

3. The resource regulating device of claim 1, wherein the usage policy comprises a threshold value for the policy parameter.

4. The resource regulating device of claim 1, wherein the usage policy comprises a range of values for the policy parameter.

5. The resource regulating device of claim 1, wherein the action comprises at least one of turning the resource consuming device off, turning the resource consuming device on, time-shifting a function of the resource consuming device, time-shifting cycles of the resource consuming device, and drawing and storing the resource in the resource consuming device.

6. The resource regulating device of claim 1, wherein the processor is further configured to switch from a first resource provider to a second resource provider.

7. The resource regulating device of claim 1, wherein the resource is one of power, gas, and water.

8. The resource regulating device of claim 1, wherein the processor is further configured to communicate with the resource consuming device using one of a wired connection and a wireless connection.

9. The resource regulating device of claim 1, wherein the second usage policy is based at least in part on user information.

10. The resource regulating device of claim 1, wherein the second usage policy is provided by a resource provider.

11. The resource regulating device of claim 9, wherein reconciling the usage policy and the second usage policy comprises selecting one of the usage policy and the second usage policy.

12. The resource regulating device of claim 9, wherein reconciling the usage policy and the second usage policy comprises combining the usage policy and the second usage policy.

13. The resource regulating device of claim 1, wherein the policy parameter is received from a resource provider.

14. The resource regulating device of claim 1, wherein the policy parameter is received from the resource consuming device.

15. The resource regulating device of claim 1, wherein the policy parameter is received from a plurality of resource consuming devices coupled with the resource consuming device.

16. The resource regulating device of claim 1, wherein the resource credits are pre-paid resource credits.

17. The resource regulating device of claim 1, wherein the resource credits are post-paid resource credits.

18. The resource regulating device of claim 1, wherein the resource regulating device comprises a smart-meter.

19. The resource regulating device of claim 1, wherein the resource regulating device is coupled with a smart-meter.

20. The resource regulating device of claim 1, wherein the user information received is a usage policy program.

21. The resource regulating device of claim 20, wherein the first processor is further configured to identify one or more usage policies for the resource consuming device based in part on the usage policy program.

22. The resource regulating device of claim 1, wherein the user information received is a third-party resource planner.

23. A method of regulating resource usage, the method comprising:
receiving user information defining a usage policy for a resource consuming device, the usage policy defining at least one action based on a policy parameter, the policy parameter comprising one of a price, time, price schedule, stored resources, generated resources, resource credits, resource budget, resource provider, and resources consumed;
receiving a second usage policy for the resource consuming device;
periodically receiving the policy parameter;
reconciling the usage policy and the second usage policy based at least in part on the policy parameter; and
transmitting a signal causing the execution of the action defined by the usage policy.

24. The method of claim 23, wherein receiving user information comprises receiving a threshold value for the policy parameter.

25. The method of claim 23, wherein receiving user information comprises receiving a range of values for the policy parameter.

26. The method of claim 23, wherein transmitting a signal causing the execution of the action comprises one of turning the resource consuming device off, turning the resource consuming device on, time-shifting a function of the resource consuming device, time-shifting cycles of the resource consuming device, and drawing and storing the resource in the resource consuming device.

27. The method of claim 23, further comprising switching from a first resource provider to a second resource provider.

28. The method of claim 23, wherein the resource consuming device consumes one of power, gas, and water.

29. The method of claim 23, wherein receiving comprises wirelessly receiving.

30. The method of claim 23, wherein transmitting comprises wirelessly transmitting.

31. The method of claim 23, wherein receiving a second usage policy for the resource consuming device comprises receiving user information defining the second usage policy.

32. The method of claim 23, wherein receiving the second usage policy for the resource consuming device comprises receiving the second usage policy from a resource provider.

33. The method of claim 23, wherein receiving the policy parameter comprises receiving the policy parameter from a resource provider.

34. The method of claim 23, wherein receiving the policy parameter comprises receiving the policy parameter from the resource consuming device.

35. The method of claim 23, wherein receiving the policy parameter comprises receiving the policy parameter from a plurality of resource consuming devices coupled with the resource consuming device.

36. A resource regulating device comprising:
means for receiving user information defining a usage policy for a resource consuming device, the usage policy defining at least one action based on a policy parameter, the policy parameter comprising one of a price, time, price schedule, stored resources, generated resources, resource credits, resource budget, resource provider, and resources consumed;
means for receiving a second usage policy for the resource consuming device;
means for periodically receiving the policy parameter;
means for reconciling the usage policy and the second usage policy based at least in part on the policy parameter; and
means for transmitting a signal causing the execution of the action defined by the usage policy.

37. A non-transitory computer-readable medium comprising instructions that, when executed by a processor of an apparatus, cause the apparatus to:
receive user information defining a usage policy for a resource consuming device, the usage policy defining at least one action based on a policy parameter, the policy parameter comprising one of a price, time, price schedule, stored resources, generated resources, resource credits, resource budget, resource provider and resources consumed;
receive as second usage policy for the resource consuming device;
periodically receive the policy parameter;
reconcile the usage policy and the second usage policy based at least in part on the policy parameter; and
transmit a signal causing the execution of the action defined by the usage policy.
